(19) United States
(12) Patent Application Publication
(10) Pub. No.: US 2010/0120400 A1
(43) Pub. Date: May 13, 2010

(54) Method and Apparatus Pertaining to Facilitating Remotely Archiving Information Regarding Auxiliary- Purpose Native Capabilities

(75) Inventors: Gary L. DeGregorio, Sleepy Hollow, IL (US); Von Mock, Boynton Beach, FL (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 12/270,404

(22) Filed: Nov. 13, 2008

(51) Int. Cl. H04L 12/58; H04M 1/00

(52) U.S. Cl. 455/412.1; 455/556.1

(57) ABSTRACT

A portable, personal apparatus (200) having native wireless two-way communications capability (202) along with a primary-purpose native capability and at least one auxiliary-purpose native capability detects (101) an inputting of data as corresponds to that auxiliary-purpose native capability. In response to making this detection, the apparatus then automatically transmits (103), via the aforementioned native wireless two-way communications capability, archival information as corresponds to the data to a previously specified target destination

### TECHNICAL FIELD

This invention relates generally to two-way communications.

### BACKGROUND

Portable and personal devices having native wireless two-way communications capability are well known and are becoming more ubiquitous over time. In most cases, such devices have a primary-purpose native capability such as facilitating two-way wireless voice communications between an end user of the device and a remotely-located party. Increasingly, however, such devices also have one or more auxiliary-purpose native capabilities.

When the device comprises, for example, a cellular telephone, examples of auxiliary-purpose native capabilities include capturing digital photographic images, effecting a near-field point-of-sale financial transaction, and so forth. Numerous other examples are presently known in these regards and additional examples will no doubt be introduced in the future. In many instances it may be desirable (or even necessary) to retain some archival record as corresponds to the carrying out of such auxiliary-purpose native capabilities.

This archiving preference, however, can often entail considerable additional steps and/or actions on the part of the end user (either at the time of carrying out the capability or at some subsequent time). In many cases this requirement can lead to errors of omission (as when the end user fails to take the appropriate follow up actions) and/or inconvenience for the end user.

### BRIEF DESCRIPTION OF THE DRAWINGS

The above needs are at least partially met through provision of the method and apparatus pertaining to facilitating remotely archiving information regarding auxiliary-purpose native capabilities described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a portable, personal apparatus having native wireless two-way communications capability along with a primary-purpose native capability and at least one auxiliary-purpose native capability detects an inputting of data as corresponds to that auxiliary-purpose native capability. In response to making this detection, the apparatus then automatically transmits, via the aforementioned native wireless two-way communications capability, archival information as corresponds to the data to a previously specified target destination.

By one approach, this archival information can comprise an unabridged version of the data. By another approach, this archival information can comprise an abridged version of the data. Encryption can be used as desired to encrypt the archival information prior to such transmissions.

So configured, these teachings will facilitate, for example, the automatic transmission of archival information to a residential location as corresponds to an end user of the portable, personal apparatus. As a related example, these teachings will also facilitate the automatic transmission of archival information to an enterprise location as corresponds to the end user and/or to the enterprise that sponsors or is otherwise associated with that portable, personal apparatus. (As used herein, “enterprise” will be understood to refer in general to third party institutions including, but not limited to, service providers of various kinds including the likes of Google, IBM, Hewlett Packard, America On-Line, and so forth.)

Those skilled in the art will recognize and appreciate that these teachings can serve to leverage a wide variety of auxiliary-purpose native capabilities. These can range from capabilities that pertain to matters of uniquely personal interest to matters of professional and/or industrial applicability. It will also be recognized that these teachings are highly scalable and can be applied successfully with a widely varying number of such auxiliary-purpose native capabilities. As these teachings can be applied in a manner that leverages the already-available native wireless two-way communications capabilities of the enabling platform, these teachings are also available for use in a highly economical manner.

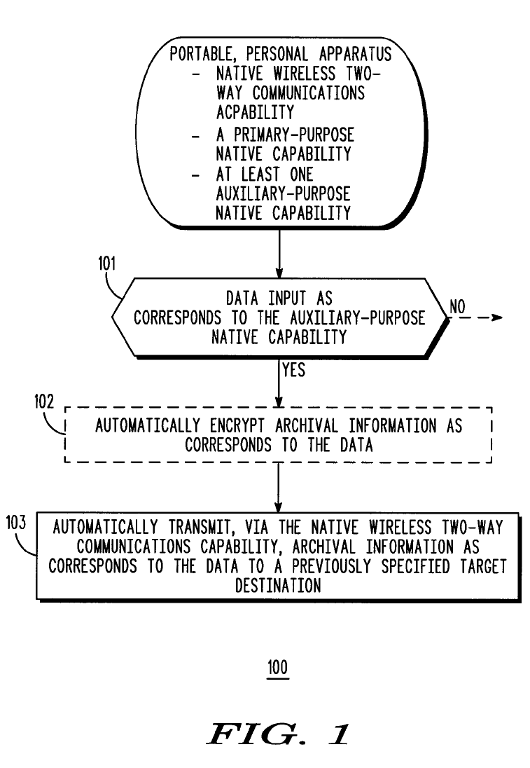

These and other benefits may become clearer upon making a thorough review and study of the following detailed description. Referring now to the drawings, and in particular to FIG. 1, an illustrative process that is compatible with many of these teachings will now be presented.

This process 100 can be carried out, for example, by a portable, personal apparatus having native wireless two-way communications capability. (As used herein, the expression “native” refers to functionality that is an inherent presently-enabled capability of the platform; to illustrate, one native capability of an ordinary pencil is the ability to leave an erasable visible mark on a surface such as paper. This can include functionality that is facilitated by remote components such as sensors of various kinds that provide their data to the apparatus via, for example, wi-fi or Bluetooth transmissions. The expression “portable” will be understood to refer to a platform that is readily carried by and on the person of an average adult human being.) In the illustrative examples provided herein, it will be presumed that this two-way communications capability includes at least the ability to transceive digital data representing any of a wide variety of payload content. By one approach, for example, this portable, personal apparatus can comprise a cellular telephone that is able to transceiver digital data (via a native wireless capability) using one or more wide area cellular telephony approaches and/or shorter range approaches (such as, but not limited to, an 802.1X-family-compatible approach, a Bluetooth-compatible approach, a light-based approach (such as an infrared-based approach) and so forth). Those skilled in the art will recognize that other possibilities exist in this regard as well with yet others likely to be developed going forward.

Also for purposes of these illustrative examples, it will be further presumed that this portable, personal apparatus has both a primary-purpose native capability and at least one auxiliary-purpose native capability. The primary-purpose native capability can comprise, for example, an ability to conduct two-way cellular telephony (via, for example, a cellular telephone network of choice).

The auxiliary-purpose native capability can vary with the application setting as will be well appreciated by those skilled in the art. Examples in this regard include, but are not limited to, capturing digital photographic images (using, for example, an included digital camera), effecting a near-field point-of-sale financial transaction (where the expression “near-field” will be understood to refer to a measure of proximity that is within three meters), monitoring environmental constituents (such as gases, chemical toxins, and so forth) or personal medical parameters (such as blood pressure, heart rate, and so forth), and so forth. Generally speaking, these teachings are particularly useful with auxiliary-purpose native capabilities that include an inputting of data as a part of their functionality and/or purpose.

This process 100 includes the step 101 of detecting an inputting of data as corresponds to the auxiliary-purpose native capability. In the absence of such input, these teachings will support the carrying out of such other activities as may be useful or necessary in a given application setting. This step of determining whether such data is being input can be repeated as often as may be desired. For example, in some application settings, it may be useful to check for such input at least once every half second or so. These teachings will also accommodate continuous monitoring in this regard and/or event-driven approaches (by using, for example, real-time interrupt approaches that may be more suitable for use in application settings where power consumption presents an issue of particular concern).

Upon detecting such data input, this process 100 provides the step 103 of automatically transmitting, via the aforementioned native wireless two-way communications capability, archival information as corresponds to the data to a previously specified target destination (or destinations, as the case may be). This archival information, by one approach, can comprise a substantially (or fully) unabridged version of the data (in which case, the archival information comprises, at the least, all of the input data). By another approach, this archival information can comprise, instead, an abridged version of the data. The latter may be appropriate to reduce the bandwidth requirements of transmitting the archival information and/or to reduce the storage requirements of retaining the archival information at, for example, the target destination.

By one approach, choosing between abridged or unabridged archival information can be automatically made by the apparatus. Such a decision can be dynamically based upon such criteria as may be deemed useful and relevant by the system designer in a given application setting. By another approach, such a choice may be resolved through application of a default setting in this regard. By yet another approach, if desired, choosing between these options can comprise an end user option. When using abridgement, these teachings will also accommodate a selectively variable amount or degree of abridgement if desired.

These teachings will also accommodate a range of possibilities with respect to the timing of the aforementioned transmission. By one approach, for example, this transmission can occur more or less immediately. By another approach (for example, when applied in conjunction with unabridged archival information that represents a relatively large quantity of material) this transmission might comprise a series of smaller transmissions over some period of time (such as minutes, hours, days, or the like). By yet another approach, this transmission can be delayed until favorable transmission conditions exist (for example, when a suitable quantity of bandwidth is available, when the costs of transmission meet some acceptance criterion, or the like).

As used herein, this reference to “previously specified” shall be understood to refer to a target destination(s) that has been identified for these purposes prior to the aforementioned inputting of data as corresponds to the auxiliary-purpose native capability. By one approach, this can comprise a factory setting. By another approach, the end user (or other authorized entity such as a system administrator) can be provided with the ability to enter this selection on an as-needed basis.

The target destination itself can vary with the needs and/or opportunities as tend to characterize a given application setting. For example, for some purposes, the target destination can correspond to a residential location as corresponds to an end user of the portable, personal apparatus. Such a choice may be useful, for example, when the auxiliary-purpose native capability comprises capturing digital images. In such a case, archival information comprising thumbnail versions of the captured digital images could be automatically transmitted to a media server for the end user that is located at the end user's home.

As another example in these regards, the target destination can correspond to an enterprise location as corresponds, directly or indirectly, to the end user. By one approach, for example, when the auxiliary-purpose native capability comprises effecting a near-field point-of-sale financial transaction, the archival information relating to, for example, a purchase event, can be automatically transmitted to a third party payment system or such other financial institution (or other financially-based platform or service, such as Intuit's Quicken, eBay's Paypal system, and so forth) as may be pertinent and useful to the end user.

Those skilled in the art will recognize that the examples provided above are intended to serve in an illustrative fashion and are not intended as an exhaustive presentation in these regards. In fact, numerous other possibilities exist in these regards. As just one example in these regards, if desired, a given end-user platform having, for example, a plurality of differing auxiliary-purpose components could be configured to effectively pair each such component with a different corresponding target destination. A camera function, for example, might be paired with a given online digital photo storage site while a financial component is paired with both the end user's bank and the end user's home computer. Those skilled in the art will recognize that there is no particular limit to the number or type of components and/or target destinations that can be readily accommodated by these teachings.

If desired, this process 100 will optionally accommodate the step 102 of automatically encrypting this archival information such that the archival information being transmitted by the apparatus will comprise encrypted archival information. Various approaches are known in the art in this regard. As these teachings are not overly sensitive to any particular selection in this regard, for the sake of brevity and the preservation of clarity, further elaboration in this regard will not be presented here.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this example, and again for the sake of example, it will be presumed that the apparatus 200 comprises a portable, personal apparatus. This apparatus 200 comprises both a processor 201 and one or more transceivers 202 that operably couple to the processor 201 and that serve to provide the aforementioned native wireless two-way communications capability. When multiple such transceivers are provided, it is expected that typically each such transceiver will compatibly support a different approach to communications. One, for example, might comprise a particular form of cellular telephony transceiver while another such transceiver might comprise, for example, a so-called Wi-Fi transceiver. Those skilled in the art will recognize and appreciate that such a processor can comprise a fixed-purpose hard-wired platform or can comprise a partially or wholly programmable platform. All of these architectural options are well known and understood in the art and require no further description here.

This processor 201 can be configured (via, for example, corresponding programming as will be well understood by those skilled in the art) to carry out one or more of the steps, actions, and functionality as described herein. This can comprise, for example, the steps of detecting the inputting of data as corresponds to an auxiliary-purpose native capability and then responsively automatically transmitting, via the native wireless two-way communications capability, archival information as corresponds to that data to a previously specified target destination.

The transceiver 202 itself can comprise any of a wide variety of transceiver platforms. This can include short range (such as Bluetooth), midrange (such as Wi-Fi), and/or long range (such as cellular telephony) radio frequency transceivers as are all well known in the art. Numerous other possibilities in these regards also exist with other possibilities likely to be developed in the future.

To facilitate such activities, these teachings will readily accommodate including additional optional components as desired. This can comprise, for example, one or more auxiliary-purpose components 203 that operably couple to the processor 201 such as, but not limited to, a digital camera, a barcode reader, a close range wireless interface (such as a Bluetooth interface or an infrared carrier-based interface), and so forth. This auxiliary-purpose component 203 can also comprise, if desired, an input to receive information from a remotely located sensor or the like (such as a global positional location device, a heart rate sensor, and so forth).

This can also comprise, for example, a memory 204 that operably couples to the processor 201. Such a memory 204 can serve, for example, to store the operating instructions for the processor 201, the input data that corresponds to the auxiliary-purpose native capability, or the like. This can also further comprise, for example, an end user interface 205 that also operably couples to the processor 201 to provide a mechanism for receiving end user input and/or for providing information to the end user.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

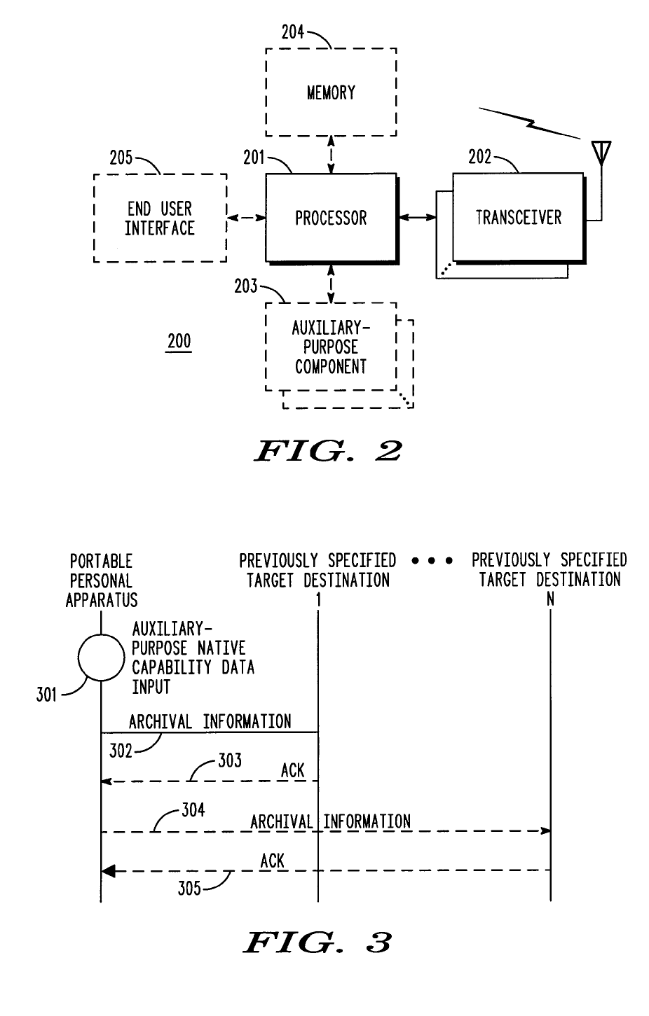

Referring now to FIG. 3, a call flow diagram that illustrates certain of these teachings will be described. In this example, a portable, personal apparatus, upon detecting auxiliary-purpose native capability data input 301, responds by transmitting corresponding archival information 302 to a first previously specified target destination.

If desired, these teachings will readily accommodate automatically transmitting this archival information to more than one such target destination. As shown, for example, the portable, personal apparatus additionally transmits archival information 304 to any number of different target destinations up to an Nth target destination (where “N” will be understood to comprise an integer value greater than one).

These teachings will also accommodate, as desired, supporting received messages as well. For example, if desired, the target destination can reply with one or more corresponding acknowledgement messages 303, 305 to indicate successful reception (and/or decoding, decryption, storage, or the like) of the transmitted archival information.

When transmitting information to multiple different target destinations, by one approach, differing versions of the archival information can be sent to different destinations. For example, one of the target destinations can receive an unabridged version of the auxiliary-purpose native capability data while another of the target destinations can receive an abridged version of the auxiliary-purpose native capability.

These teachings are highly leverageable by existing platforms and technology and are also highly scalable and hence will accommodate a wide variety and number of differing application settings and auxiliary purposes. Using these teachings, for example, financial transactions made by the end user (either with or without use of the portable, personal apparatus in that regard) can be easily archived and tracked without requiring additional follow-up actions on the part of the end user. As one simple example in this regard, the end user can take a picture (using their cellphone camera) of a sales receipt upon making a purchase and that cellphone, using these teachings, can automatically transmit that image (or the substantive content represented by that receipt using, for example, optical character recognition) to a home computer which then automatically adds that information to a personal financial tracking platform such as Quicken.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, it was noted above that these teachings will optionally accommodate the use of encryption to protect the archival information during its transit. If desired, such encryption can be used in a selective manner (where the selection is automatically determined and/or selected in a particular instance or for a particular genre or modality of archival material by the end user). As another example in these regards, it will be understood that the target destination for the aforementioned archival information can comprise a specific platform and/or a particular memory location and/or a particular application or the like.

We claim:

1. A method comprising:
at a portable, personal apparatus having native wireless two-way communications capability and further having a primary-purpose native capability and at least one auxiliary-purpose native capability:
detecting an inputting of data as corresponds to the auxiliary-purpose native capability;
in response to detecting the inputting of data, automatically transmitting, via the native wireless two-way communications capability, archival information as corresponds to the data to a previously specified target destination.

2. The method of claim 1 wherein the portable, personal apparatus comprises a cellular telephone.

3. The method of claim 2 wherein the primary-purpose native capability comprises two-way cellular telephony.

4. The method of claim 3 wherein the auxiliary-purpose native capability comprises capturing digital photographic images.

5. The method of claim 3 wherein the auxiliary-purpose native capability comprises effecting a near-field point-of-sale financial transaction.

6. The method of claim 1 wherein automatically transmitting, via the native wireless two-way communications capability, archival information as corresponds to the data comprises automatically transmitting an unabridged version of the data.

7. The method of claim 1 wherein automatically transmitting, via the native wireless two-way communications capability, archival information as corresponds to the data comprises automatically transmitting an abridged version of the data.

8. The method of claim 1 further comprising:
automatically encrypting the archival information to provide encrypted archival information;
and wherein automatically transmitting, via the native wireless two-way communications capability, archival information as corresponds to the data comprises automatically transmitting the encrypted archival information.

9. The method of claim 1 wherein the previously specified target destination corresponds to a residential location as corresponds to an end user of the portable, personal apparatus.

10. The method of claim 1 wherein the previously specified target destination corresponds to at least one of a financial institution and a financial service as corresponds to an end user of the portable, personal apparatus.

11. An apparatus comprising a portable, personal apparatus having native wireless two-way communications capability and further having a primary-purpose native capability and at least one auxiliary-purpose native capability, and further comprising a processor that is operably configured and arranged to:
detect an inputting of data as corresponds to the auxiliary-purpose native capability; and
in response to detecting the inputting of data, automatically transmit, via the native wireless two-way communications capability, archival information as corresponds to the data to a previously specified target destination.

12. The apparatus of claim 11 wherein the portable, personal apparatus comprises a cellular telephone.

13. The apparatus of claim 12 wherein the primary-purpose native capability comprises two-way cellular telephony.

14. The apparatus of claim 13 wherein the auxiliary-purpose native capability comprises capturing digital photographic images.

15. The apparatus of claim 13 wherein the auxiliary-purpose native capability comprises effecting a near-field point-of-sale financial transaction.

16. The apparatus of claim 11 wherein the processor is further configured and arranged to automatically transmit, via the native wireless two-way communications capability, archival information as corresponds to the data by automatically transmitting an unabridged version of the data.

17. The apparatus of claim 11 wherein the processor is further configured and arranged to automatically transmit, via the native wireless two-way communications capability, archival information as corresponds to the data by automatically transmitting an abridged version of the data.

18. The apparatus of claim 11 wherein the processor is further configured and arranged to:
automatically encrypt the archival information to provide encrypted archival information; and
to automatically transmit, via the native wireless two-way communications capability, the archival information as corresponds to the data by automatically transmitting the encrypted archival information.

19. The apparatus of claim 11 wherein the previously specified target destination corresponds to a residential location as corresponds to an end user of the portable, personal apparatus.

20. The apparatus of claim 11 wherein the previously specified target destination corresponds to at least one of a financial institution and a financial service as corresponds to an end user of the portable, personal apparatus.
